(19) United States
(12) Patent Application Publication
(10) Pub. No.: US 2011/0124233 A1
(43) Pub. Date: May 26, 2011

(54) Method and apparatus for power supply connection

(76) Inventors: Ernest Jerold Case, New Iberia, LA (US); Earl Edward Patton, New Iberia, LA (US)

(21) Appl. No.: 12/925,485

(22) Filed: Oct. 22, 2010

Related U.S. Application Data
(60) Provisional application No. 61/281,811, filed on Nov. 23, 2009.

(51) Int. Cl. H01R 33/00; H01R 43/00

(52) U.S. Cl. 439/638; 29/428

(57) ABSTRACT

An inexpensive adjustable power adapter assembly is provided that can easily fit within openings formed in dwellings or other structures, such as doorways or windows, and which can substantially seal any open spaces formed in such openings. The adapter permits quick and easy connection of an external power source (such as, for example, a diesel or gas-powered portable generator) to the interior of such dwelling or other structure.

### BACKGROUND OF THE INVENTION

1. Field of the Invention

The present invention pertains to an apparatus for supplying power to a dwelling, building or other structure. More particularly, the present invention pertains to an apparatus that can be used to transfer electricity from a power source, such as a portable generator or other devices to the interior space of a dwelling, building or other structure.

2. Brief Description of the Prior Art

Hurricanes, ice storms and other violent weather events, as well as floods, earthquakes and other natural disasters, can cause serious bodily injury and/or death, as well as significant damage to property. In many cases, such events can damage power supply infrastructure, causing power outages commonly referred to as “blackouts.” Depending on the severity of the damage, complexity and structure of the power network, and the scope of the remedial action required, such power outages may last from a few minutes to a few weeks.

In situations where the environment and/or public safety are at risk, such as at hospitals, sewage treatment plants, mines, and the like, “permanent” backup power sources are typically utilized. Such backup power sources frequently employ at least one standby generator that automatically start up when electrical power is lost, and that are fueled using natural gas, diesel or some other available fuel source. In many cases, such generators are permanently wired into the electrical system of the dwelling, building, or other facility being serviced. Such permanent installations should be performed by trained professionals, and can frequently be expensive undertakings.

In other instances, portable generators can be used to supply power on a temporary basis while a permanent power supply is interrupted. Portable generators can be used to power appliances such as refrigerators and/or freezers to prevent food spoilage and/or HVAC units for comfort. Portable generators can also power radios and televisions for receiving news broadcasts, as well as alarm systems for security.

Unfortunately, portable power generators pose many risks when installed or used improperly. Improperly installed portable generators can cause fires or electrocution. Further, portable generators also produce high levels of carbon monoxide (CO) in their exhaust. CO levels around generators can build up within minutes, and can linger for hours, even after generators are shut off. Thus, it is critical that such portable generators must not be located indoors or in confined areas during operation without having proper exhaust into outside areas.

In many cases, portable generators are situated outside of a dwelling or other structure, and an extension cord or other line is used to supply electricity from the generator to the interior of such dwelling or other structure through an open door or window. The disadvantage of such a configuration is the lack of a substantially air-tight seal, which allows for thermal transfer through such opening(s). Such thermal transfer can dramatically reduce the efficiency of heating or cooling within the dwelling or other structure. Further, any such opening(s) also permit carbon monoxide (CO) from a generator or other source to filter into living space, and allow insects and/or wildlife to access the interior of such dwellings or other structures.

There is a need for an inexpensive adjustable adapter assembly that can easily fit within openings formed by existing windows or doorways of dwellings or other structures, and which can allow windows or doors to substantially seal any open spaces. Such adapter should permit quick and easy connection of an external power source (such as, for example, a diesel or gas-powered portable generator) to provide power to the interior of such dwelling or other structure.

### SUMMARY OF THE PRESENT INVENTION

In the preferred embodiment, the adapter assembly of the present invention can be installed in a window or other opening of a structure, such as a dwelling, building or the like. The adapter assembly of the present invention can be used to provide an adapter or interface to supply power into the interior of said structure from a power source located outside of said structure. Further, the adapter assembly of the present invention can be used alone or, if preferred, in connection with other complementary equipment including, without limitation, conventional window-mounted air conditioning units.

The adapter assembly of the present invention can comprise a single panel. However, in the preferred embodiment, the present invention comprises at least two panel members that can be joined together to form a single, elongate adapter assembly defining “internal” and “external” surfaces. The size(s) of said at least two panel members can be adjusted so that, when joined together, the resulting adapter assembly has the desired dimensions for a particular application or use.

At least one connector device is provided on the “internal” surface (that is, the surface that is oriented toward the interior of a structure) of the present invention. Although said at least one connector device could embody many different sizes or configurations to fit particular applications, it is to be observed that said at least one connector device can beneficially be a female electrical connector or “socket” having slots or holes which accept and deliver current to the prongs of mating plugs. Similarly, at least one connector device is provided on the “external” surface (that is, the surface that is oriented toward the exterior or outside of a structure) of the present invention. Although said at least connector device can embody many different sizes or configurations to fit particular applications, it is to be observed that said at least one connector device can beneficially be a “male” electrical connector having prongs or extensions that can mate with, and receive current from, a “female” socket plug connected to a generator or other power source.

During periods of prolonged power outage or interruption, such as after a hurricane, storm, severe weather event, earthquake or natural disaster, the adapter of the present invention can be installed in a window, doorway or other opening of a structure (such as, for example, a dwelling, home or building). A power supply, such as a portable generator, can be situated a safe distance from said structure so that it does not present a fire hazard or other danger to occupants of such dwelling.

In the preferred embodiment, the present invention reduces the risk of electrical shock by utilizing an exterior weatherproof, inverted receptacle. Further, the adapter of the present invention prevents pinched, twisted, or crushed extension cords, and beneficially uses shock resistor ground fault circuit interrupter receptacles. The present invention further prevents deadly carbon monoxide (CO) and other gases from emergency power generator exhaust from filtering into living space.

The present invention can be easily, safely, and efficiently placed in more than one window or door opening should more than one emergency electrical power generator be required. If multiple generators are required, adapter apparatuses of the present invention can be strategically positioned at windows or doors where such adapters are placed.

The present invention can easily be incorporated into the design of new construction. The adapters of the present invention can be positioned in one or more strategic locations, ready to distribute electrical power supplied from a conveniently located emergency power generator.

The present invention addresses four very important safety issues when utilized in connection with an emergency power generator:
(1) Instead of running extension cords through an open window or door, the adapter of the present invention provides a safe and efficient method of allowing complete closure of such window or door, thereby preventing any carbon monoxide (CO) from generator engine exhaust from filtering into interior living space, which could cause severe injury or death to occupants of such living space.
(2) Haphazard placement of extension cords is eliminated. Using conventional methods of connecting temporary power supplies, extension cords are frequently extended through open windows or doors and often get pinched, twisted, or crushed which could cause electrical shock or fire. The present invention reduces such hazards.
(3) The use of the 2-pole, 3-wire, 125 volt, 20 amp shock resistor ground fault circuit interrupter receptacles in the preferred embodiment prevents serious electric shock from ground faults. Any contact with a live (hot) wire will cause the GFCI to detect a problem, and will automatically shut-off the power supply to the interior of a dwelling or structure.
(4) The 15/20 amp, 125 volt, and 30 amp, 250 volt inverted receptacles, located on the exterior facing side of the adapter of the present invention, meet all safety code requirements, and reduce the risk of electrical shock.

### BRIEF DESCRIPTION OF THE DRAWINGS

The foregoing summary, as well as the following detailed description of the preferred embodiments, is better understood when read in conjunction with the appended drawings. For the purpose of illustrating the invention, the drawings show certain preferred embodiments. It is understood, however, that the invention is not limited to the specific methods and devices disclosed.

FIG. 1 depicts a side perspective view of the adapter assembly of the present invention utilized in connection with a window-mounted air conditioning unit from inside a dwelling or other structure.

FIG. 2 depicts a side perspective view of the adapter assembly of the present invention utilized in connection with a window-mounted air conditioning unit from outside a dwelling or other structure.

FIG. 3 depicts a side sectional view of the adapter assembly of the present invention utilized in connection with a window-mounted air conditioning unit.

FIG. 4 depicts an overhead view of the adapter assembly of the present invention utilized in connection with a window-mounted air conditioning unit.

FIG. 5 depicts an exploded perspective view of the adapter assembly of the present invention.

FIG. 6 depicts a side view of the adapter assembly of the present invention.

FIG. 7 depicts a side view of the adapter assembly of the present invention.

FIG. 8 depicts a side perspective view of an alternative embodiment of the adapter assembly of the present invention utilized in connection with a conventional window-mounted air conditioning unit from inside a dwelling or other structure.

FIG. 9 depicts a side perspective view of an attachment fitting of the present invention.

FIG. 10 depicts a side perspective view of the alternative embodiment of the adapter assembly of the present invention.

FIG. 11 depicts a side perspective view of the alternative embodiment of the adapter assembly of the present invention from the opposite side as depicted in FIG. 10.

FIG. 12 depicts a side sectional view of the alternative embodiment of the adapter assembly of the present invention utilized in connection with a window-mounted air conditioning unit and portable power supply.

FIG. 13 depicts a detailed side sectional view of a portion of the alternative embodiment of the adapter assembly of the present invention depicted in FIG. 12.

### DETAILED DESCRIPTION OF A PREFERRED EMBODIMENT OF THE INVENTION

Referring to the drawings, FIG. 1 depicts a side perspective view of adapter assembly 100 of the present invention utilized in connection with window-mounted air conditioning unit 10. As depicted in FIG. 1, adapter assembly 100 is mounted within window 30 of dwelling 20 having interior wall surface 21, with FIG. 1 depicting a perspective from the interior of said dwelling 20. It is to be observed that adapter assembly 100 can be used in any number of different applications beyond the specific configuration depicted in FIG. 1. As such, although the present invention is described herein as being used in connection with doors or windows of dwellings, adapter assembly 100 can be used with different types of openings other than doors or windows. Further, adapter assembly can be used with structures other than dwellings such as, for example, commercial buildings, trailers, temporary buildings and the like.

Still referring to FIG. 1, sliding window 30 having glass 31, frame 32 having inner frame surfaces 33 and window sill 34 is opened a sufficient distance to receive air conditioning unit 10 within said opening in window 30. If desired, expandable panels 11 can be extended from the sides of air conditioning unit 10 within such opening in window 30, thereby substantially sealing any lateral opening(s) along the sides of said air conditioning unit 10.

Adapter assembly 100 can be installed above air conditioning unit 10, and window 30 can be closed to secure air conditioning unit 10 within window frame 32, substantially sealing any openings around said air conditioning unit 10 and adapter assembly 100. It is to be observed that adapter assembly 100 can, alternatively, be installed in other potential positions relative to air conditioning unit 10 and/or window 30 without departing from the scope of the present invention such as, for example, below said air conditioning unit 10. Power cord 12 of air conditioning unit 10 has plug 13, which can be mated with internal connection assembly 120 of adapter assembly 100.

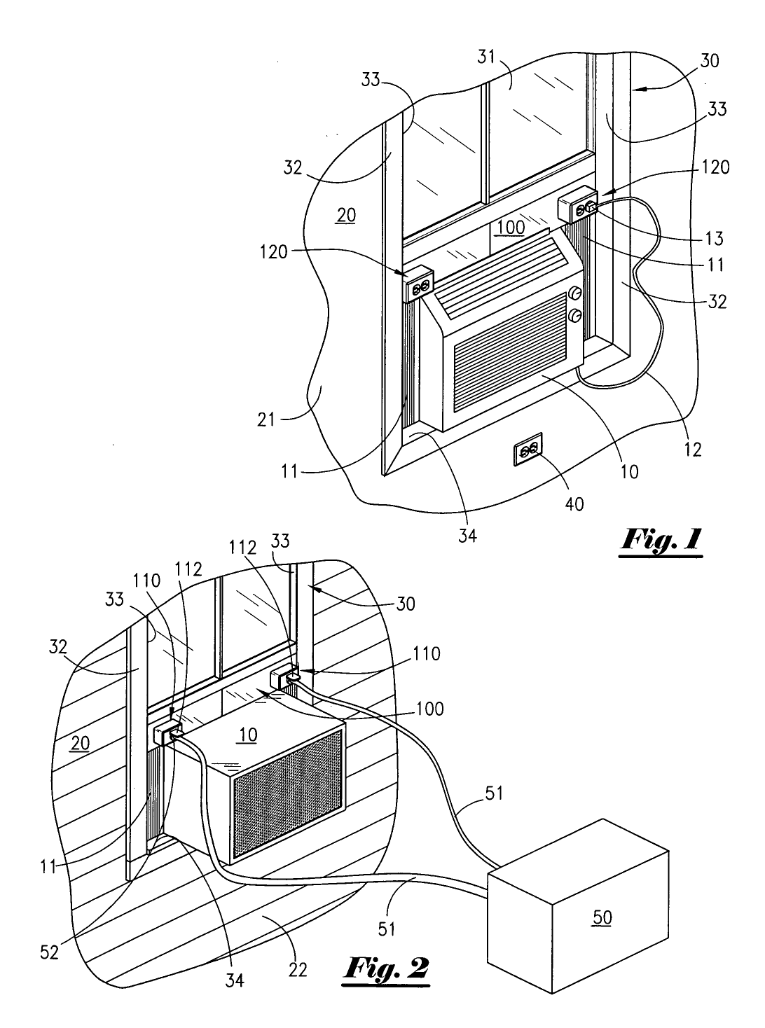

FIG. 2 depicts a side perspective view of adapter assembly 100 of the present invention utilized in connection with a window-mounted air conditioning unit 10 from a perspective outside dwelling 20 having exterior surface 22. As in FIG. 1, adapter assembly 100 is mounted within window 30 of dwelling 20. Sliding window 30 having glass 31, frame 32 having inner frame surfaces 33 and window sill 34 is opened a sufficient distance to receive air conditioning unit 10 within said opening in window 30. Expandable panels 11 can be extended laterally to contact inner window frame surfaces 33 and substantially seal the side areas adjacent to air conditioning unit 10.

Adapter assembly 100 is installed above air conditioning unit 10, and window 30 can be closed to secure air conditioning unit 10 within window frame 32, and substantially seal any openings around said air conditioning unit 10 and adapter assembly 100. As noted above, adapter assembly 100 can, alternatively, be installed in other potential positions relative to air conditioning unit 10 and/or window 30 without departing from the scope of the present invention.

Portable generator 50 is positioned at a desired location in the general vicinity of dwelling 20; provided, however, that portable generator 50 should beneficially be located in a position that ensures that any hazards associated with said portable generator 50 are minimized. For example, portable generator 50 should be positioned a sufficient distance from dwelling 20 so that exhaust fumes from said portable generator 50 are permitted to safely vent into the atmosphere, and will not enter the interior spaces of dwelling 20. Further, portable generator 50 should be situated a sufficient distance from dwelling 20 so that dwelling 20, and any inhabitants thereof, are not at risk of possible fire associated with portable generator 50 spreading to said dwelling 20.

Power supply cords 51, in the preferred embodiment having “female” configured socket plug assemblies 52, extend from portable generator 50 to adapter assembly 100. Socket plug assemblies 52 are mated with external connection assemblies 110 of adapter assembly 100. Power supply cords 51 are conduits that permit the flow of electricity from portable generator 50 to adapter assembly 100 and, ultimately, to electrical-powered devices or appliances situated within dwelling 20 (such as, for example, air conditioning unit 10).

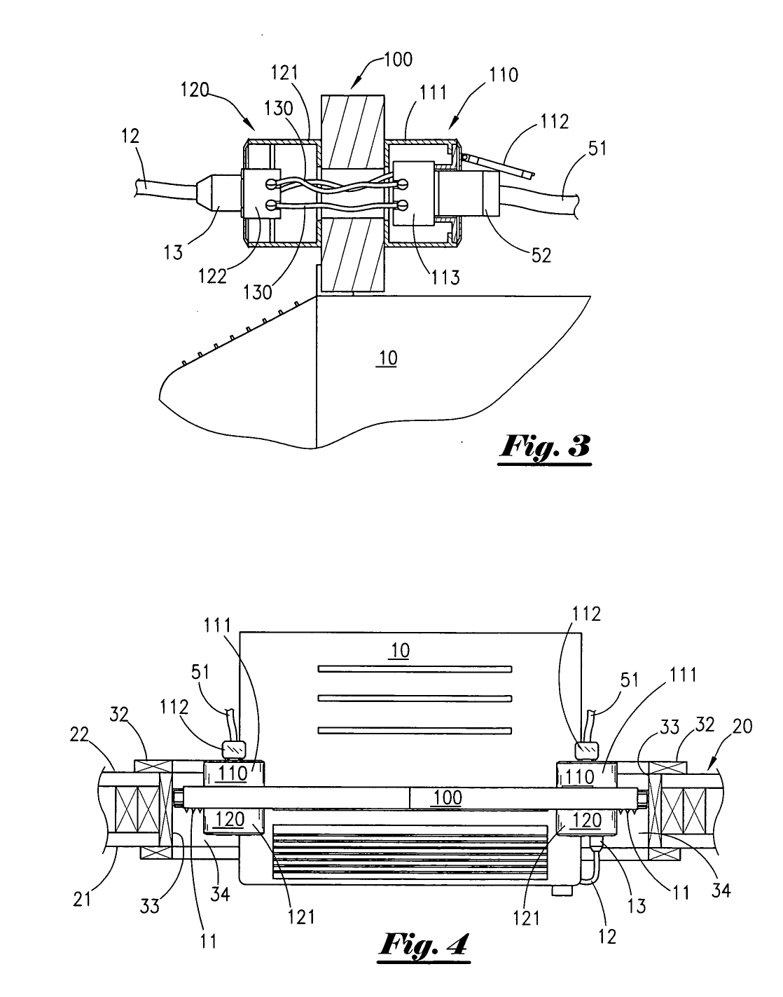

FIG. 3 depicts a side sectional view of adapter assembly 100 of the present invention utilized in connection with window-mounted air conditioning unit 10. Adapter assembly 100 can be installed above air conditioning unit 10 as depicted in FIG. 3; however, adapter assembly 100 can also be installed in other potential locations or configurations relative to air conditioning unit 10 without departing from the scope of the present invention.

Power supply cord 51, having “female” socket plug assembly 52 at its distal end, extends from portable generator 50 (not shown in FIG. 3) to adapter assembly 100. In the preferred embodiment, external connection assembly 110 comprises external housing 111, cover 112 and outlet assembly 113 having “male” prong extension members. Cover 112 can beneficially close over an aperture or opening in external housing 111, said cover thereby preventing unwanted access to prong extension members located within said external housing 111. Further, in the preferred embodiment, said cover 112 can include a biasing device (such as a spring or the like) to bias cover 112 in a closed position to prevent said cover 112 from being inadvertently left open. Plug assembly 52 is mated with prong extension member(s) of outlet assembly 113 of external connection assembly 110.

Similarly, power cord 12 of air conditioning unit 10 has plug 13, which can be connected into internal connection assembly 120 of adapter assembly 100. In the preferred embodiment, internal connection assembly 120 comprises housing 121 and socket member 122, wherein said socket member 122 generally comprises a “female” receptacle configuration used for conventional power outlets. In the preferred embodiment, said socket member 122 beneficially comprises a 2-pole, 3-wire, shock resistor ground fault circuit interrupter. Plug 13, having male prong extensions, is plugged into and mated with socket member 122.

Wires 130 extend from external outlet assembly 113 of external connection assembly 110 to socket member 122 of internal connection assembly 120. Such wires 130 are connected in a manner well known by those having ordinary skill in the art of electrical wiring so as to permit the flow of electricity from socket member 122 to outlet assembly 113.

FIG. 4 depicts an overhead view of adapter assembly 100 of the present invention utilized in connection with a window-mounted air conditioning unit 10. Dwelling 20 has interior wall surface 21, exterior wall surface 22 and window 30 defining an opening generally between said surfaces. Window 30 has frame 32 defining inner frame surfaces 33 and window sill 34. Expandable panels 11 are laterally extended to contact inner window frame surfaces 33 and secure air conditioning unit 10 within frame 32 of window 30 and substantially seal any lateral opening(s) along the sides of such air conditioning unit 10.

Adapter assembly 100 is installed above air conditioning unit 10. Power cord 12 of air conditioning unit 10 has plug 13, which can be plugged into socket 122 of internal connection assembly 120 of adapter assembly 100. Power supply cord 51 having socket plug 52 at its distal end extends from portable generator 50 (not shown in FIG. 4) to external connection assembly 110, wherein socket plug 52 is mated with male extension prongs of outlet assembly 113 of external connection assembly 110.

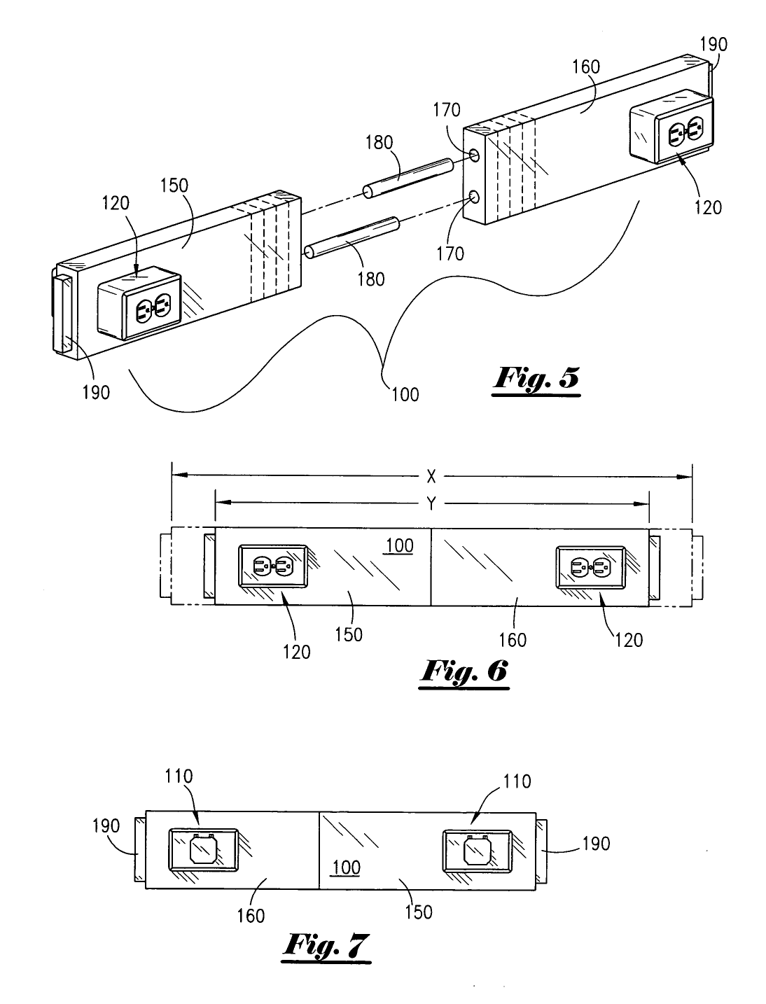

FIG. 5 depicts an exploded perspective view of adapter assembly 100 of the present invention. In the preferred embodiment, adapter assembly 100 comprises first elongate panel member 150 and second elongate panel member 160. The view depicted in FIG. 5 represents a perspective view showing the side of adapter apparatus 100 that would normally face the interior of a dwelling or other structure. As such, at least one internal connection assembly 120 is visible on one side of each of elongate panel members 150 and 160. It is to be observed that external connection assemblies are disposed on the opposite side of said elongate panel members 150 and 160, but are mostly obscured from view in FIG. 5.

Still referring to FIG. 5, elongate panel members 150 and 160 each have at least one bore 170 that runs substantially parallel to the longitudinal axis of said elongate panel members. Connection rods 180, having appropriate dimensions, are partially received within said at least one bore 170 of each adjoining panel member 150 and 160. Said connection rods 180 frictionally fit within said at least one bore 170 to hold said elongate panel members 150 and 160 together. The length of adapter assembly 100 can be adjusted by trimming one or both elongate panel members 150 and 160 along the dashed lines shown in FIG. 5. Wing-like extensions 190 extend laterally from the outer ends of panel members 150 and 160, and can fit within vertical channels found in many common window frame configurations in order to secure said panels 150 and 160 in place.

FIG. 6 depicts a side view of adapter assembly 100 of the present invention, formed by joining first elongate panel member 150 to second elongate panel member 160 in the manner described above. Dimension “X” represents said elongate panel members 150 and 160 joined to form adapter assembly 100, while dimension “Y” represents said elongate members 150 and 160 joined to form a shorter version of adapter assembly 100 after one or both of said elongate panel members 150 and/or 160 have been trimmed to the desired size(s). In this manner, the size of adapter assembly 100 can be adjusted to fit windows or other openings having different dimensions.

FIG. 7 depicts a side view of adapter assembly 100 of the present invention formed by joined elongate panel members 150 and 160. The view depicted in FIG. 7 represents a perspective view showing the side of adapter apparatus 100 that would normally face the exterior or outside of a dwelling or other structure. As such, at least one external connection assembly 110 is visible on one side of each of elongate panel members 150 and 160.

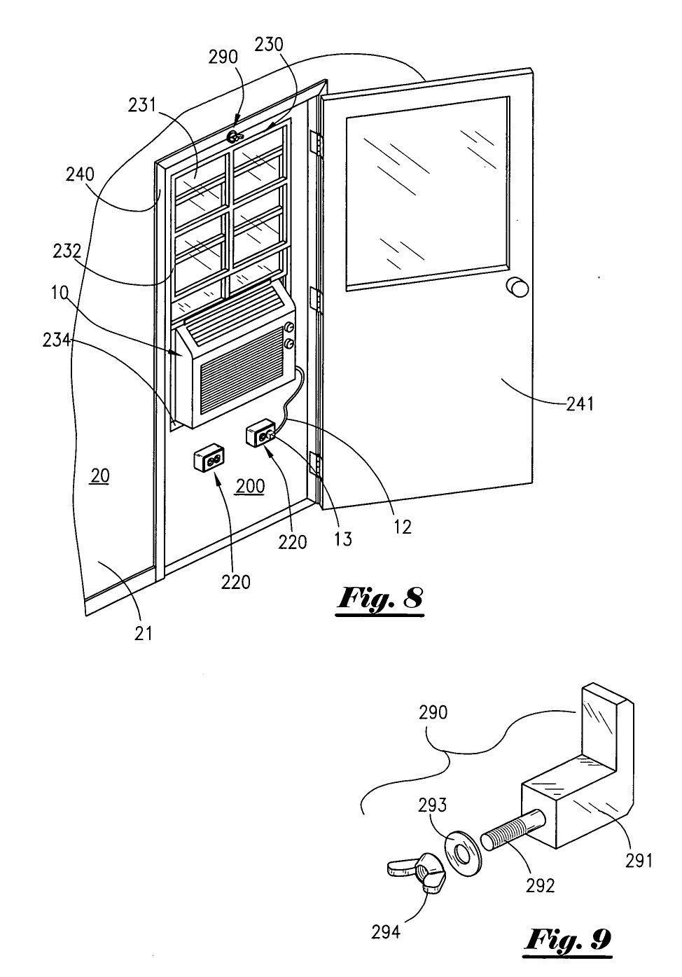

FIG. 8 depicts a side perspective view of an alternative embodiment of adapter assembly 200 of the present invention utilized in connection with a conventional window-mounted air conditioning unit 10 from inside a dwelling or other structure. As depicted in FIG. 8, adapter assembly 200 is mounted within door frame 240 of dwelling 20 having open door 241 and interior wall surface 21; FIG. 8 being from the perspective of the interior of said dwelling 20. However, it is to be observed that adapter assembly 200 can be used in any number of different applications beyond the specific configuration depicted in FIG. 8.

Still referring to FIG. 8, sliding window 230 having glass 231, frame 232 and window base 234 is opened a sufficient distance to receive air conditioning unit 10 within said opening formed by window 230. If needed, expandable panels 11 can be extended laterally from air conditioning unit 10 to substantially seal any lateral opening(s) along the sides of such air conditioning unit 10. Power cord 12 of air conditioning unit 10 has plug 13 which can be plugged into and electrically connected to internal connection assembly 220 of adapter assembly 200.

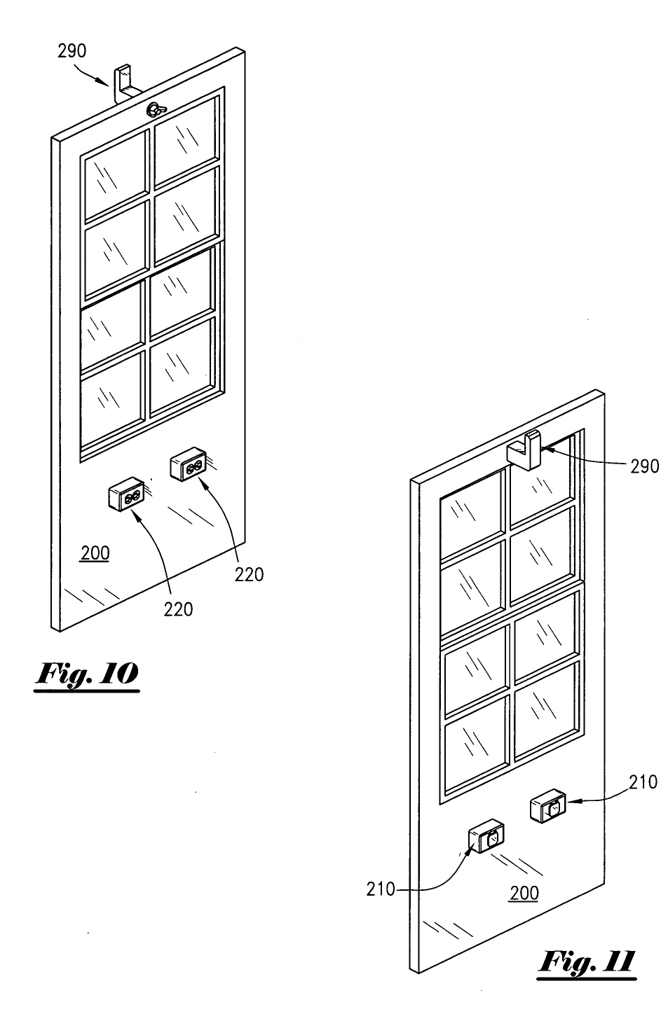

FIG. 9 depicts a side perspective view of an attachment fitting 290 of the present invention that can be used to shim or firmly secure alternative embodiment adapter assembly 200 within door frame 240. In the preferred embodiment, attachment fitting 290 includes locking member 291, threaded bolt 292, washer 293 and wing nut 294. Locking member 291 defines an angled surface (depicted as 90° in FIG. 9). In use, threaded bolt 291 can be inserted through an aperture in adapter 200. Washer 293 and wing nut 294 can be installed on said bolt to secure attachment fitting 290 and hold adapter 200 in place within door frame 240.

FIG. 10 depicts a side perspective view of the alternative embodiment adapter assembly 200 of the present invention having internal electrical connection assemblies 220; in the preferred embodiment, said alternative adapter embodiment 200 would be oriented so that said internal electrical connection assemblies 220 are facing the interior of a dwelling or other structure. FIG. 11 depicts a side perspective view of the alternative embodiment adapter assembly 200 of the present invention having external electrical connection assemblies 210 from the opposite side as the view depicted in FIG. 10; in the preferred embodiment, said alternative adapter embodiment 200 can be beneficially oriented so that said external electrical connection assemblies 210 would be facing the interior of a dwelling or other structure.

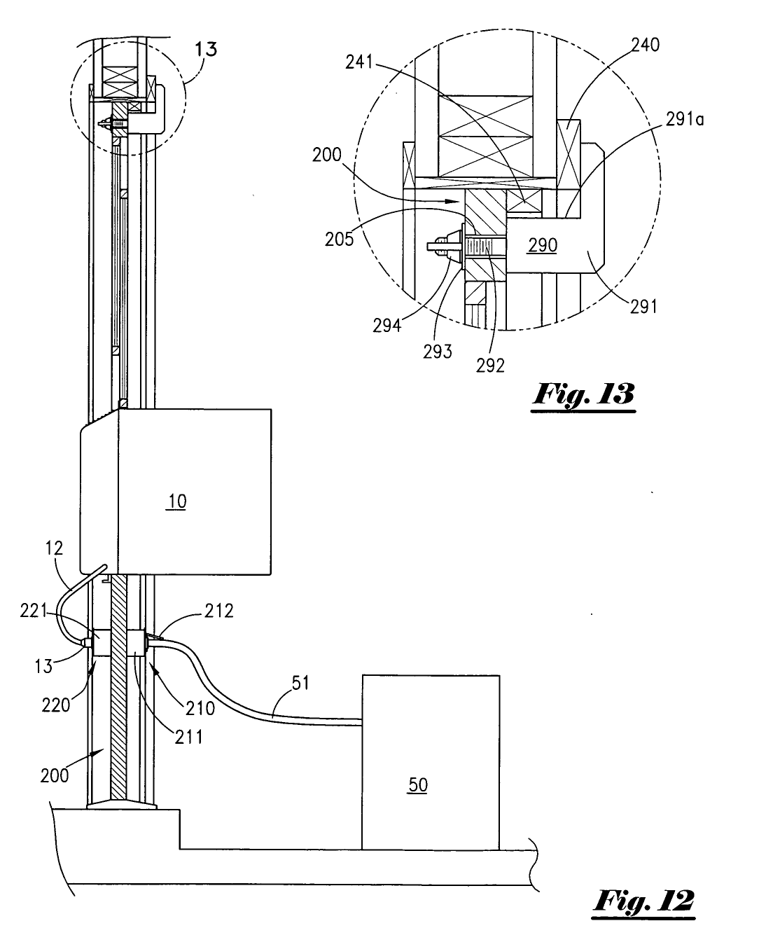

FIG. 12 depicts a side sectional view of alternative embodiment adapter assembly 200 of the present invention installed in a door frame 240 and utilized in connection with a window-mounted air conditioning unit and portable power supply.

Power supply cord 51 having “female” socket plug assembly 52 at its distal end extends from portable generator 50 to adapter assembly 200. In the preferred embodiment, external electrical connection assembly 210 comprises external housing 211, cover 212 and at least one “male” extension prong member disposed within said housing. Cover 212 can close over an aperture or opening in external housing 211, said cover 212 thereby preventing unwanted access to the internal space(s) within said external housing 211. Further, in the preferred embodiment, said cover 212 can be biased in a closed position to prevent said cover 212 from being inadvertently left open. Plug 52 is mated with the “male” prong member(s) of external electrical connection assembly 210.

Similarly, power cord 12 of air conditioning unit 10 has plug 13, which can be electrically connected to internal connection assembly 220 of adapter assembly 200. In the preferred embodiment, internal connection assembly 220 comprises housing 221 and a socket member, wherein said socket member has a “female” receptacle configuration commonly utilized on conventional power outlets. Plug 13, having male extension prongs, is plugged into and electrically connected with said internal socket member.

FIG. 13 depicts a detailed side sectional view of a portion of the alternative embodiment of adapter assembly 200 of the present invention depicted in FIG. 12. As shown in FIG. 12, threaded bolt 292 of attachment fitting 290 is received within aperture 205 extending through alternative adapter assembly 200. When washer 293 and wing nut 294 are installed on said threaded bolt 292, a portion of locking member 291 (having upper surface 291 a defining right-angle) contacts door frame 240. As wing nut 294 is tightened, alternative adapter assembly 200 is biased against horizontal bend jams 241, thereby securing adapter assembly 200 in place with said doorway.

During periods of prolonged power outage or interruption, such as after a severe weather event or natural disaster, the adapter of the present invention can be installed in a door, window or other opening of a structure (such as, for example, a dwelling, home or building). A power supply, such as a portable generator, can be situated a safe distance from said structure so that it does not present a fire hazard or other danger to occupants of such dwelling.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A power adapter apparatus comprising:
a. a substantially planar adapter member having opposing first and second surfaces;
b. at least one receptacle disposed on said first surface; and
c. at least one receptacle disposed on said second surface, wherein said at least one receptacle disposed on said first surface is electrically connected to said at least one receptacle disposed on said second surface.

2. The power adapter of claim 1, wherein said at least one receptacle disposed on said first surface further comprises a ground fault interrupter receptacle.

3. The power adapter of claim 1, wherein said at least one receptacle disposed on said second surface further comprises:
a. a housing; and
b. a male electrical connector disposed within said housing.

4. A power adapter apparatus comprising:
a. a substantially planar adapter member comprising:
i. a first elongate panel member having opposing first and second surfaces;
ii. a second elongate panel member having opposing first and second surfaces, wherein said second elongate panel member is connected to said first elongate panel member;
b. at least one receptacle disposed on each of said first and second surfaces of said first elongate panel member; and
c. at least one receptacle disposed on each of said first and second surfaces of said second elongate panel member, wherein said at least one receptacle disposed on said first surfaces are electrically connected to said at least one receptacle disposed on said second surfaces.

5. The power adapter of claim 1, wherein said at least one receptacle disposed on said first surfaces further comprises a ground fault interrupter receptacle.

6. The power adapter of claim 1, wherein said at least one receptacle disposed on said second surfaces further comprises:
a. a housing; and
b. a male electrical connector disposed within said housing.

7. A method of connecting power from a generator to the interior of a structure comprising:
a. installing a power adapter apparatus within an opening is said structure, wherein said power adapter apparatus comprises:
i. a substantially planar adapter member having opposing first and second surfaces;
ii. at least one receptacle disposed on said first surface; and
iii. at least one receptacle disposed on said second surface, wherein said at least one receptacle disposed on said first surface is electrically connected to said at least one receptacle disposed on said second surface;
b. supplying power to said adapter apparatus from a generator situated outside of said structure to said at least one receptacle on said first surface.
c. connecting at least one power cord from a generator situated outside of said structure to said at least one receptacle on said first surface.
